(19) United States
(12) Patent Application Publication
(10) Pub. No.: US 2003/0208407 A1
(43) Pub. Date: Nov. 6, 2003

(54) System and Method for Commodity Futures Contract Trading Risk Management

(75) Inventor: Mr. Donovan A. Dawson, Dallas, TX (US)

Correspondence Address: Alvin R. Wirthlin, Akin, Gump, Strauss, Hauer & Feld, LLP, 1700 Pacific Avenue, Suite 4100, Dallas, TX, 75201, US, awirthlin@akingump.com, 214-969-2800, 214-969-4343

(73) Assignee: Arcufutures, Inc., Dallas, 75219 (US)

(21) Appl. No.: 09/546,951

(22) Filed: Apr. 11, 2000

(51) Int. Cl. G06F 17/60

(52) U.S. Cl. 705/26

(57) ABSTRACT

### Abstract of the Disclosure

A system for trading commodity futures contracts and options is provided. The system includes a user account system that has user-entered trade data, such as to buy a commodity futures contract for copper. A user information system is connected to the user account system and provides commodities trading data to users, such as a description of what a commodity futures contract is, and how copper prices have historically fluctuated. A trading controls system connected to the user account system receives user account data from the user account system and inhibits the user-entered trade data in response to the user account data.

### Background of the Invention

### Field of the Invention

The present invention pertains to the field of commodity futures contract trading. More specifically, the invention relates to a system and method for commodity futures contract trading risk management that provides trading assistance to account holders based upon user-entered risk management data.

Commodities future trading involves the buying and selling of contracts for the sale and purchase of commodities. In the past, commodities were generally limited to actual physical commodities, such as corn, hoofed animals, oil, and other similar tangible property. Presently, commodities also include intangible property, such as bonds, stock indexes, and other similar assets. While not presently allowed under United States securities laws, commodities trading on individual stocks may eventually also be allowed.

One problem inherent with commodity futures contract trading is the high level of uncertainty and risk involved. Commodity futures are optimally used to cover positions, such as to protect a large amount of tangible or intangible goods from loss in the event of large fluctuations in the market. However, many investors choose to invest in commodity futures because of the large potential gains that can be made.

It is customary for a broker or other operator that is trained and familiar with such risks to assist users when placing trades. For example, if a user places a trade to buy a contract for the right to purchase 10,000 pounds of copper, then a commodities broker or trader will typically suggest various strategies to the user to minimize the user's downside potential. Because many users are unfamiliar with the various aspects of commodities future trading, such interaction with traders can be time intensive and may limit the number of trades that can be handled by such personnel. As a result, the cost for such assistance increases. Likewise, the quality of such assistance may depend the training and skill of the broker assisting the user. Thus, suitable exit options may not be discussed or presented to the user if the broker assisting the user is inexperienced or does not have sufficient time to devote to the user.

### Summary of the Invention

In accordance with the present invention, a system and method for commodity futures contract trading risk management are provided that overcome known problems with commodity futures contract trading.

In particular, a system and method for commodity futures contract trading risk management are provided that present a user with trade options for minimizing risk in commodity futures contract trading.

In accordance with an exemplary embodiment of the present invention, a system for trading commodity futures contracts and options is provided. The system includes a user account system that has user-entered trade data, such as an order to buy a commodity futures contract for copper. A user information system is connected to the user account system and provides commodities trading data to users, such as a description of what a commodity futures contract is, and how copper prices have historically fluctuated. A trading controls system connected to the user account system receives user account data from the user account system and inhibits the user-entered trade data in response to the user account data, such as if the user has insufficient capital with which to cover the trade or other positions in the user's account.

The present invention provides many important technical advantages. One important technical advantage of the present invention is a system and method for commodity futures contract trading that allows users to place trades without operator assistance. The present invention provides users with information that is usually provided by an operator, such as cover trades that will limit potential losses, definitions, commodity price history data, and other suitable data. Thus, the user is provided with predetermined information that ensures that the user can make informed decisions, and does not have to rely on an operator, who may give incorrect information or be otherwise unavailable.

Those skilled in the art will further appreciate the advantages and superior features of the invention together with other important aspects thereof on reading the detailed description that follows in conjunction with the drawings.

### Brief Description of Drawings

FIGURE 1 is a diagram of a system for commodity futures contract trading risk management in accordance with an exemplary embodiment of the present invention;

FIGURE 2 is a diagram of a user trading system in accordance with an exemplary embodiment of the present invention;

FIGURE 3 is a diagram of a commodity futures contract trading system in accordance with an exemplary embodiment of the present invention;

FIGURE 4 is a diagram of a method for commodity futures contract trading risk management in accordance with an exemplary embodiment of the present invention; and

FIGURE 5 is a flowchart of method for managing portfolio risk for a commodity futures contract trading user in accordance with an exemplary embodiment of the present invention.

### Detailed Description of Preferred Embodiments

In the description which follows, like parts are marked throughout the specification and drawings with the same reference numerals, respectively. The drawing figures may not be to scale and certain components can be shown in generalized or schematic form and identified by commercial designations in the interest of clarity and conciseness.

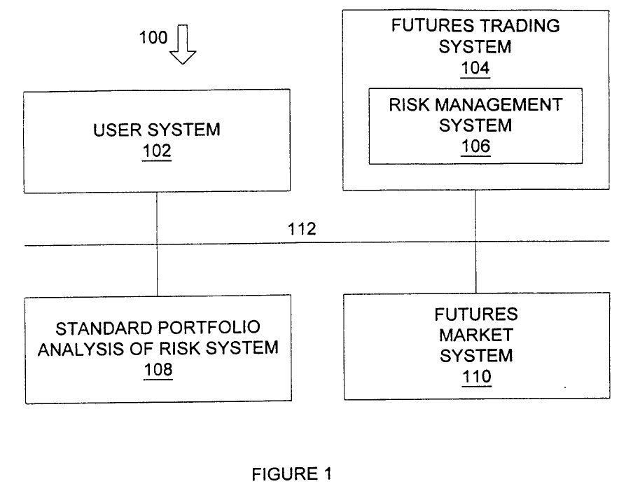

FIGURE 1 is a diagram of a system 100 for commodity futures contract trading risk management in accordance with an exemplary embodiment of the present invention. System 100 can be used to allow a user to place commodity futures contract trades without operator assistance and to provide improved service to users, where user risk profile data is used to generate cover trade selections when the user places a commodity futures contract trade.

System 100 includes user system 102 which is coupled to futures contract trading system 104 via communications media 112. User system 102 can be implemented in hardware, software, or a suitable combination of hardware and software, and can be one or more software systems operating on a general purpose computing platform. As used herein, a software system can include one or more lines of code, objects, agents, subroutines, separate software applications, and can also include two or more separate lines of code operating in two or more different software applications, or other suitable software architectures. In one exemplary embodiment, a software system can include one or more lines of code, objects, agents, or subroutines in a general purpose software application, such as an operating system, and one or more lines of code, objects, agents, subroutines or other software structures in a specific purpose software application.

User system 102 can be implemented as *.HTML code or other suitable code that is downloaded for use in conjunction with a web browsing software system operating on a general purpose computing platform. User system 102 is coupled to futures contract trading system 104 via communications medium 112. As used herein, the term "couple" and its cognate terms such as "coupled" and "couples" can include a physical connection (such as a copper conductor), a virtual connection (such as through randomly-assigned memory locations of a data memory device), a logical connection (such as through logical gates of a semiconducting device), through suitable combinations of such connections, or through other suitable connections. For example, systems or components can be coupled through intervening systems or components, such as through an operating system of a computing platform.

User system 102 allows a user to access futures contract trading system 104 over the communications medium 112 such that the user can place trades in the user's account from any location in which the user has access to the communications medium 112. Communications medium 112 can be the Internet, the public switched telephone network, a local area network, a wide area network, a wireless network, a combination of such communications media, or other suitable communications media. User system 102 also allows the user to select user risk profiles, and to receive other suitable data from futures contract trading system 104 for the generation of graphical user interface screens and the entry of data for transmission to futures contract trading system 104.

Futures contract trading system 104 can be implemented in hardware, software, or a suitable combination of hardware and software and can be one or more software systems operating on a general purpose server platform. Futures contract trading system 104 includes risk management system 106. Futures contract trading system 104 allows a user to place commodity futures trades without operator assistance. In one exemplary embodiment, futures contract trading system 104 presents a user with the various classes of commodity futures contracts that are available. These commodity futures contracts can include contracts that give the user the right to purchase or sell a set quantity of commodities at a predetermined price, within a predetermined time, at a predetermined location, or other suitable contracts. Likewise, the futures contract trading system 104 can present a user with options, which are options to buy and sell such contracts.

By way of further example, a commodity futures contract may give a user the right to purchase a commodity, such as 10,000 pounds of copper, within a predetermined time period, such as 3 months, at a projected market price, such as $1.00 per pound. This exemplary contract would have an intrinsic value of $10,000, but the entity that is selling the copper might charge the user a down-payment of only 10 percent for the contract, or $1000. Thus, the user can control 10,000 pounds of copper for a payment of only $1,000. If the price of copper increases to $2.00 per pound within 3 months, then the user can sell the 10,000 pounds of copper for $20,000, pay the seller the extra $9000 plus interest due on the contract, and keep the remainder as profit. In contrast, if the price of copper decreases to $0.50 a pound, then the user must sell the 10,000 pounds of copper for $5,000 and pay the seller the extra $9000 plus interest due on the contract. Thus, the user must have additional money in his account to cover that sale.

Instead of buying a contract, the user may buy an option to buy the contract. In the foregoing example, the user might pay $2000 for an option to buy a contract to purchase 10,000 pounds of copper at the current market price of $1.00 per pound. In this example, if the price of copper goes up to $2.00 per pound, the user can execute his option and purchase the contract, then sell the copper for $20,000, and must then pay the seller $10,000 with little or no interest. Unlike the commodity futures contract, though, if the price of copper drops to $0.50 per pound, then the user only loses the $2000 paid for the option contract.

Futures contract trading system 104 also provides the user with trading assistance. For example, terminology and trading strategy advice are made available to the user through a suitable user interface such as a help index, hypertext links to web pages that contain explanatory material, pull-down menus, exploding text windows that appear when a term is highlighted by a user's cursor, or other suitable features. In this manner, a user that is unfamiliar with terminology can receive instruction on the meaning of the terminology without fear of appearing untrained or inexperienced. Futures contract trading system 104 also provides users with consistent advice and descriptions, such that the user is not at risk from receiving incorrect information from an unskilled operator.

Futures contract trading system 104 includes risk management system 106. Risk management system 106 allows a user to enter risk profile data that can be used to assist the user in selecting trades. For example, risk management system 106 can generate prompts, graphic user interfaces, or other suitable displays through user system 102 that prompt the user to enter the following information:

1. User experience level

2. User risk identifier (such as ranging from "very risk adverse" to "willing to accept large amounts of risk")

3. Default stop loss percentages (such as 70% of contract price, 50% of initial portfolio amount, 80% of current portfolio amount, or other suitable level selections)

4. Investment options (such as cover inventory, purchase options, purchase contracts, or other suitable criteria)

Risk management system 106 thus allows users to input data that can be used to assist the user with the placement of commodity futures trades. For example, if a user indicates that they are not experienced and do not wish to risk more than 80% of the value of any given contract, then the user can be presented with certain exit strategies when an options trade is placed. In the example previously discussed, if the user places a trade to purchase a contract to buy 10,000 pounds of copper at the current price of $1.00 per pound and with an expiration of three months, then the user can be prompted, based upon the user risk information, to place an offer to sell their contract at the market price when the price of copper reaches $0.80 per pound. In this manner, the user's contract position can be closed out without the user having to continuously watch the price of copper, and the user's loss would be limited to $2000, plus transaction fees.

Risk management system 106 can also prompt the user with the choice of buying an option to sell 10,000 pounds of copper at the price of $0.80 per pound. The price of this option would be much relatively small, since the price of copper would have to drop over $0.20 per pound before the option would be worth anything. Nevertheless, if the price of copper does not fall, then the user will still have lost an amount equal to the price of the option, whereas placing the order to sell the 10,000 pounds of copper at the price of $0.80 per pound would have no cost in this scenario. The advantage of an option is that the user is under no pressure prior to the expiration of the option to sell after the price of copper reaches $0.80 per pound, such that the user can hold onto the contract and the option until they both expire. The user therefore stands to recoup losses if the price of copper increases while incurring no additional losses if the price of copper drops further. In contrast, once the user sells his contract at $0.80 per pound, then the user no longer has a position, and does not stand to recoup any losses if the price of copper increases.

System 100 also includes the Chicago Board of Trade Standard Portfolio Analysis of Risk (SPAN) System 108. Standard Portfolio Analysis of Risk System 108 is a software system operated by the Chicago Board of Trade that is used to analyze user account data to determine the amount of money that should be in the account to cover known volatility of commodity futures holdings. For example, the Standard Portfolio Analysis of Risk System 108 receives current contract and option holdings for all commodities traded on the Chicago Board of Trade and calculates the amount of capital that must be held in order to offset any potential risk from price fluctuations. Such calculations are based on historical price variations over the long-term, over the short-term, and other subjective data that may be based on news, political developments, and other information. Likewise, the number and value of futures contracts placed on various commodities can also be used to determine the amount of liquid capital required to cover various account positions. Thus, in the foregoing example where the user purchases a contract to buy 10,000 pounds of copper at $1.00 per pound, if the price of copper drops to $0.50 per pound, then Standard Portfolio Analysis of Risk System 108 can determine that, based upon historical price fluctuations of copper and current political and news data, that $6000 of liquid capital is presently required to be held in the account of the user in order to cover any potential loss. Likewise, if the price of copper were to increase to $1.50 per pound, then the Standard Portfolio Analysis of Risk System 108 can determine that the user's contract position does not require any liquid capital to be held in the account to cover the position. This information is provided to futures contract trading system 104, which can determine whether the user currently has the required amount of liquid capital in their account and can notify the user through user system 102 of any deficiencies.

Futures market system 110 can be implemented in hardware, software, or a suitable combination of hardware and software, and can be one or more software systems operating on one or more general purpose server platforms. Futures market system 110 provides pricing and availability data for futures contracts and options. For example, futures market system 110 can be operated by a commodity futures broker that represents various institutions that produce or hold large quantities of commodities. These institutions can sell contracts to buy and sell commodities so as to hedge rapid fluctuations in the market. Futures market system 110 receives information about the present availability and price of options, contracts, and commodities, provides the information to futures contract trading system 104, and can interface with the commodities future brokers to effect trades.

In operation, system 100 allows users to trade commodity futures contracts and options without operator assistance, while providing sufficient information to the user to minimize risk. In this manner, system 100 allows users to place trades without requiring operator assistance, such that the users are not dependent upon the advice of any given operator. Thus, users are provided with consistent levels of advice that can be reviewed to ensure that the users are able to make informed decisions regarding the risks of various options positions. Likewise, the users will be provided with exit strategies that can allow the user to limit the potential downside of any purchases.

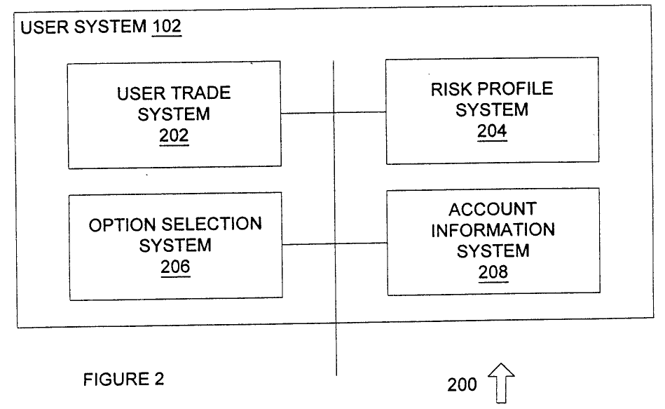

FIGURE 2 is a diagram of a user trading system 200 in accordance with an exemplary embodiment of the present invention. User trading system 200 includes user system 102 and additional system functionality.

User trading system 200 includes user trade system 202, risk profile system 204, option selection system 206, and account information system 208, each of which can be implemented in hardware, software, or a suitable combination of hardware and software, and which can be implemented as *.HTML code that is downloaded to a general purpose processing platform for use with web browser software, such that they are coupled to each other through the web browser software or the operating system of the general purpose processing platform. User trade system 202 presents a user with commodity futures contract and option trading information. In one exemplary embodiment, user trade system 202 presents a series of graphical user interfaces that display to the user the various types of commodities for which a contract or option can be purchased, the prices of contracts and options, purchase quantities and prices for selected options and contracts, and other suitable information. The user may initially be presented with a list of various classes of commodities, such as produce, minerals, precious metals, bonds, stocks, and other suitable classes. If the user selects one of these classes, such as stocks, the user may then be presented with additional options contract information such as various index futures, futures for individual stocks, and other suitable futures data. The user may then make further selections until a particular futures commodity is selected.

For example, the user can select to buy options or futures contracts for copper. The user may then be presented with various futures contracts that may currently be purchased, such as the right to buy or sell 10,000 pounds of copper for various periods of time, such as:

| | | Copper - |
|---|---|---|
| | Copper - | Standard |
| | Hi Grade | Grade |
| Quarter1Year1 | 1.00 | 0.80 |
| Quarter2Year1 | 1.02 | 0.81 |
| Quarter3Year1 | 1.07 | 0.82 |
| Quarter4Year1 | 1.10 | 0.83 |
| Quarter1Year2 | 1.10 | 0.84 |
| Quarter2Year2 | 1.15 | 0.85 |
| Quarter3Year2 | 1.17 | 0.86 |
| Quarter4Year2 | 1.19 | 0.87 |

User trade system 202 presents this information and other suitable information to the user in a manner that allows the user to determine whether or not to make the trade.

User trade system 202 can also interface with other system functionality of futures contract trading system 104 or other suitable systems. For example, user trade system 202 can provide the user with access to a user information system that supplies information upon request, such as basic definitions, trade examples, historical data, news, or other suitable data. User trade system 202 can also interface with other systems, such as a trading controls system that prevents users from placing trades that they lack sufficient liquid capital to cover, an account monitor system that notifies users of changes in account status that may exceed user risk profile data, and other suitable systems.

Risk profile system 204 generates graphic user interfaces that present queries to the user and which allow the user to enter data for use in selecting covering positions based upon risk levels. The user can access risk profile system 204 as needed so as to update or modify risk profile data.

Option selection system 206 is used to present covering options to a user based upon data from risk profile system 204 and user trade system 202. In the foregoing example, if the user has purchased a contract to buy 10,000 pounds of copper and has risk profile data reflecting a preferred stop loss amount per contract of 80 percent, then the user can be presented with the following covering positions:

1. Place order to sell contract when price of copper drops to $0.80 per pound.

2. Buy option to purchase sales contract for 10,000 pounds of copper at $0.80 per pound for $2000.

3. Buy option to purchase sales contract for 10,000 pounds of copper at $0.70 per pound for $500.

The user can then select a covering position from the choices presented, request additional covering positions, opt to purchase no covering position, request additional information, or make other suitable selections.

Account information system 208 can generate graphic user interfaces that display account information to the user. For example, a user may open an account with $500,000, and may take out contracts that require advance payment of $200,000. Over time, the user may be required by the Chicago Board of Trade to have $200,000 in their account to cover these contracts, based upon historical price fluctuation data, subjective criteria, empirical criteria, and other data. Account information system 208 can generate user-readable displays that show the user how much money is available in their account, how much money must be kept in their account in order to cover their current positions, and other suitable data.

In operation, system 200 allows a user to manage commodity futures contract trading without operator intervention. System 200 allows users to place trades and provides users with cover position trades that will limit their downside potential. While the user can also receive assistance online, or can be provided with access to online operator assistance or phone numbers so that they can call an operator for additional assistance, system 200 provides users with improved quality of service by providing consistent information that is continuously available.

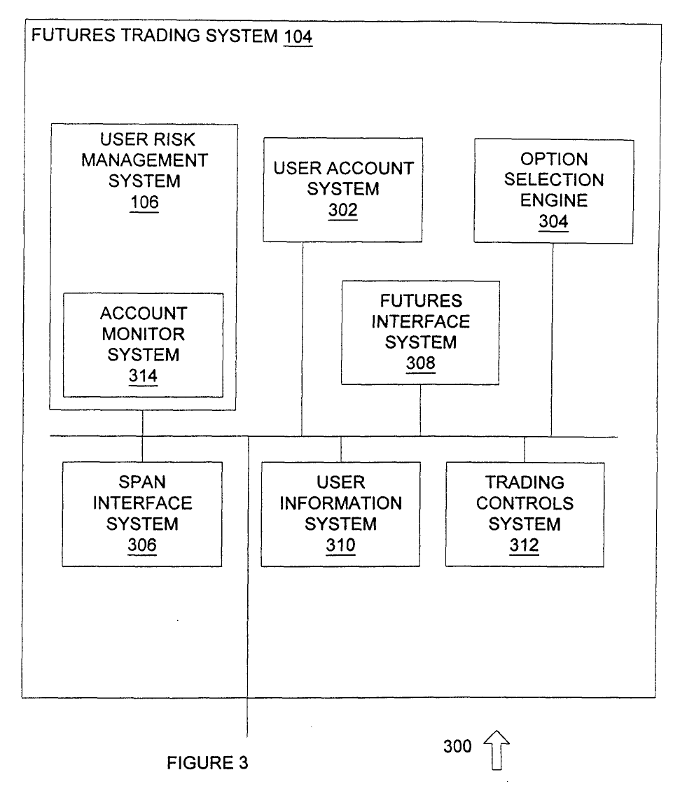

FIGURE 3 is a diagram of a commodity futures contract trading system 300 that includes futures contract trading system 104 and additional functionality, in accordance with an exemplary embodiment of the present invention. System 300 can be used to manage accounts for multiple users and is accessible over a communications medium, such as the Internet, the public switched telephone network, or other suitable communications media.

System 300 includes user risk management system 106, user account system 302, option selection engine 304, SPAN interface system 306, futures interface system 308, user information system 310, trading controls system 312, and account monitor system 314, each of which can be implemented in hardware, software, or a suitable combination of hardware and software, and which can be one or more software systems operating on a general purpose server platform, such that they are coupled to each other through the operating system of the general purpose server platform. User account system 302 allows users to access their account data and place trades through user system 102. For example, user account system 302 can track password data, the amount of capital, options positions, contract holdings, risk profile data, and other user-specific account information.

Option selection engine 304 can receive user risk data from user risk management system 106, trade data from user account system 302, and futures and options data from futures interface system 308, and can select covering futures contracts and options for users based upon futures contracts and option purchases made by the user, user risk data, and available contracts and options.

SPAN interface system 306 interfaces with the Chicago Board of Trade Standard Portfolio Analysis of Risk System 108 to provide user account positions for analysis and to receive user account liquid capital requirements. For example, SPAN interface system 306 can receive user account positions from user account system 302, and can provide those user positions to the Chicago Board of Trade Standard Portfolio Analysis of Risk System 108 in a format that prevents the identity of the user from being disclosed. The Chicago Board of Trade Standard Portfolio Analysis of Risk System 108 tabulates all contract and option positions, and determines liquidity requirements for each account based upon volatility data for commodities, the number of contracts held, the number of options held, and other suitable data. SPAN interface system 306 receives the liquidity requirements and provides that information to user account system 302. User account system 302 then determines whether the amount of cash held in the user's account is sufficient to cover current positions, or whether changes in commodity prices have resulted in contract value changes that require the user to either close out positions or provide additional capital or security.

Futures interface system 308 interfaces with commodity futures brokers and receives current commodity futures contracts and options prices and availability. For example, futures interface system 308 can interface with multiple commodity brokers and can store prices and quantities of options available. Futures interface system 308 can also transmit requests for futures contracts that are currently not being offered, such that futures brokers can determine whether or not to place bids on such contracts.

User information system 310 can present information regarding futures contracts and options to a user upon demand. For example, user information system 310 can include hypertext links that direct the user to web pages that contain a description of a term, examples of how the term is used, what the term signifies, and other suitable information. User information system 310 can also include an index of terms, pull-down menus of terms, exploding windows or pop-up windows that appear when the user's cursor is placed over a term, or other suitable information and formats of data.

Trading controls system 312 can process user trades and user account information to determine whether a trade that has been ordered by a user would cause the user's account to exceed the amount of capital requirements for the account. For example, if the user presently has $10,000 in their account, and the Standard Portfolio Analysis of Risk System 108 indicates that the user must have at least $9000 of liquid capital to cover their existing positions, then the user may not be allowed to purchase any more contracts if such purchase would result in the amount of liquid capital dropping below $9000. Trading controls can also be used to limit trading to options, certain types of futures contracts, or other suitable categories.

Account monitor system 314 can receive user risk management data, SPAN data, and account data and can determine whether contract or option trades either may or must be executed by the user. For example, if the SPAN data indicates that the user should have $10,000 in liquid capital and the user only has $1000, then the user will be presented with trade combinations that could be enacted to either remove the position that requires the cover, or to provide sufficient capital. The user can also provide additional capital. Likewise, if the user's risk management data indicates that the user's present positions have exceeded any risk parameters, such as decreases in total account value or decreases in original investment value, then contract or options trades can be recommended to the user that will reduce the user's risk. For example, if the user risk data includes a stop loss of 80 percent of contract initial value and the user opted not to cover that contract, the user may be notified when the contract value drops below 80 percent of its initial value and may further be presented with cover trade options.

In operation, system 300 is used to provide commodities future trading users with access to their accounts, trading, risk management, and other information without operator assistance. System 300 interfaces with the Chicago Board of Trade and futures and options brokers and presents data received from these parties to users in addition to covering positions that can be used to minimize downside risk for users.

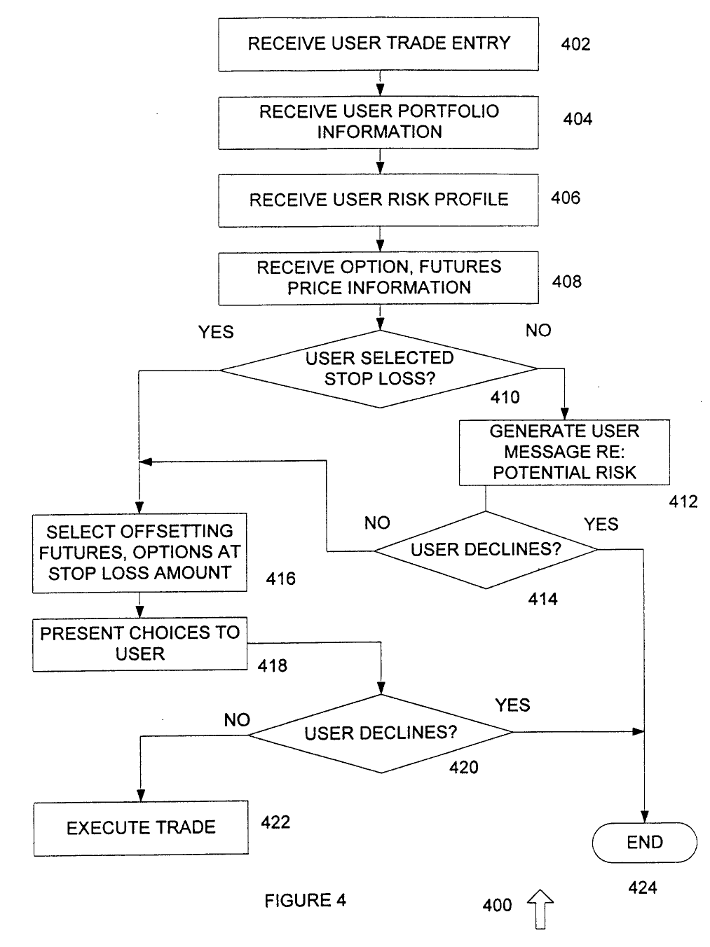

FIGURE 4 is a diagram of a method 400 for commodity futures contract trading risk management in accordance with an exemplary embodiment of the present invention. Method 400 begins at 402 where a user trade entry is received. For example, the user trade entry can be received prior to execution of the trade, when the trade is performed, or after the trade has been performed. The method then proceeds to 404.

At 404, user portfolio data is received. The user portfolio data can include futures contracts and options held by the user, the amount of liquid capital in the user's account, the user's trading history, background data about the user, and other suitable information. The method then proceeds to 406 where user risk profile data is received. The user risk profile data can include user-selected data that indicates the level of risk that the user is willing to accept, the familiarity of the user with commodity futures contracts and options trades, stop loss criteria, and other suitable information. The method then proceeds to 408.

At 408, options and futures contracts price information is received. For example, the commodity futures contracts and options price information can be received in response to queries, such that the prices are current real-time prices, are updated periodically, or other suitable procedures can be used. The method then proceeds to 410.

At 410, it is determined whether the user has selected a stop loss position in the user's risk profile. In one exemplary embodiment, a stop loss position can be selected for individual trades, for the user's entire account, or other suitable stop loss selections can be made. If it is determined that a user has selected the stop loss position, then the method proceeds to 416. Otherwise, the method proceeds to 412 and a user message is generated regarding the potential risks in placing a trade without an offsetting position. The method then proceeds to 414. If the user declines to purchase a covering position at 414, the method proceeds to 424 and terminates. Otherwise, the method proceeds to 416.

At 416, cover positions for futures contracts and options for the stop loss amount are selected. The stop loss selections can include futures contracts trade orders that will close at the position at prices corresponding to user-entered risk criteria, options that will provide protection corresponding to user-entered risk criteria, or other suitable cover positions. The method then proceeds to 418 where the futures contracts and options choices are presented to the user, such as by listing the choices, each with a user-selectable control. The method then proceeds to 420, where the user either accepts or declines to execute a cover trade or to select any of the choices. If the user declines all choices, the method proceeds to 424 and terminates. Otherwise, the method proceeds to 422 where the cover trade selected by the user is executed. As previously indicated, this trade data can include the initial trade entered by the user, or may only include the cover trade presented to the user at step 416.

In operation, method 400 is used to present a user with risk management data so that the user can minimize downside potential of commodity futures contracts and options purchases. Method 400 automatically generates cover trade selections for offsetting purchases based upon user risk profile selection data so that the user is provided with the option of covering trades without the need for operator involvement. Likewise, method 400 helps to prevent improper operator advice, such as recommending covering positions that do not sufficiently cover the user from downside potential, in accordance with the user's risk objectives.

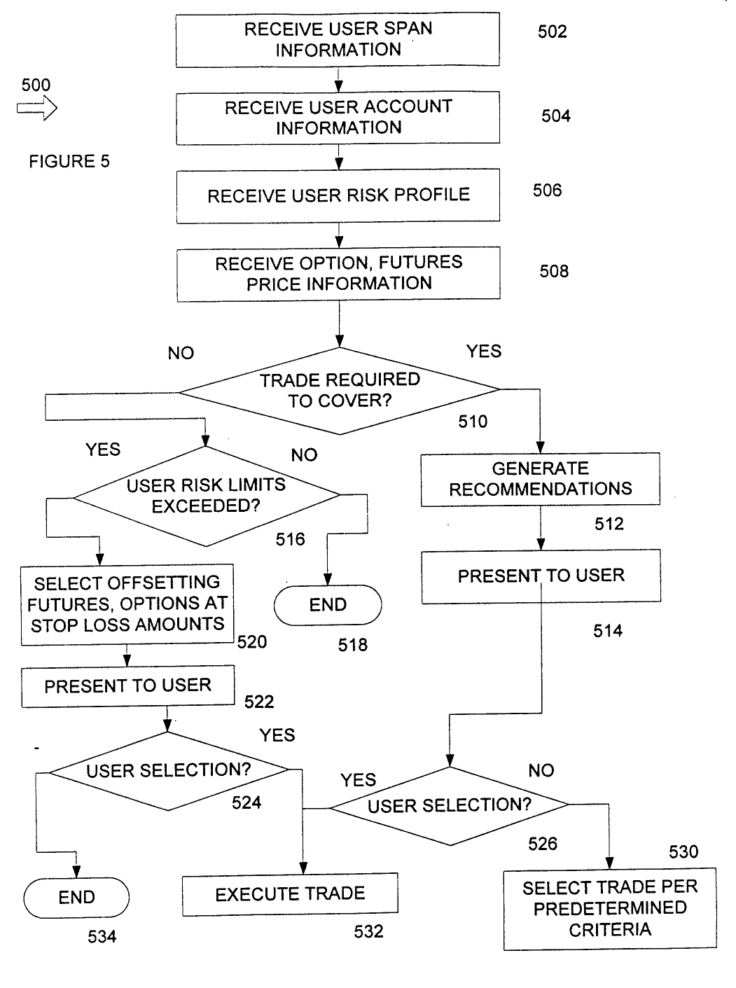

FIGURE 5 is a flowchart of method 500 for managing portfolio risk for a commodity futures contract trading user in accordance with an exemplary embodiment of the present invention. Method 500 can be implemented on a daily basis after receiving information from the Chicago Board of Trade or other suitable authorities regarding the amount of liquid capital that a user must have in their account, on a continuous basis, or at other suitable intervals.

Method 500 begins at 502 where user SPAN information is received, such as from the Chicago Board of Trade Standard Portfolio Analysis of Risk System, or other suitable portfolio risk data. The method then proceeds to 504 where user account information is received, such as the user's current amount of liquid capital, the user's current positions, and other information about the user, such as the number of trades performed, historical trading volume, and other suitable information. The method then proceeds to 506.

At 506, user risk profile information is received. User risk profile information can include user-entered data that identifies maximum amounts that the user wishes to place at risk, risk amounts for individual contracts or trades, and other suitable risk data. The method then proceeds to 508 where options and commodity futures contracts price information is received, such as from one or more commodity brokers. The method then proceeds to 510.

At 510, it is determined from the user SPAN information whether a trade is required to cover the user's positions. For example, the SPAN information may include a required amount of liquid capital that must be held by the user in their account in order to continue owning the futures contracts held by the user, based upon market volatility and other information. If the amount of capital in the user's account is not sufficient to meet this requirement, then the user must trade one of the contracts to raise capital, close out the position, buy or sell an option, provide more liquid capital, or otherwise protect the downside potential. If it is determined at 510 that a trade is required to cover, the method proceeds to 512 where recommendations are generated. For example, the user may hold five options contracts where liquid capital is required to cover one of the contracts, and the remaining four would result in a net profit if closed out and have no liquid capital cover requirements. If the amount of capital required to close out the contract with cover requirements is less than the amount of liquid capital that the user has, the user could choose to close out the contract and maintain the remaining positions in the account. Likewise, the user could also choose to close out one of the profitable contracts so as to generate capital to cover the unprofitable contract, could add capital, or could choose other suitable options. After recommendations are generated at 512, the method proceeds to 514.

At 514, the close out recommendations are presented to the user. The user can be notified according to a predetermined notification regimen, such as by email first, then by a telephone call, then by a facsimile transmission, and then by telegram, or by other suitable procedures. The method then proceeds to 526 where it is determined whether a user selection has been received. If no user selection is received, such as if the user cannot be reached, or if the user otherwise refuses to make a selection, then a trade can be selected for the user based upon predetermined criteria and contractual provisions with the user regarding trading to cover positions in the account. Likewise, if the user opts to provide more liquid capital, then no trade is selected at 530. Otherwise, the method proceeds to 532 and the trade is executed.

If it is determined at 510 no trade is required to cover, the method proceeds to 516 where it is determined whether the user risk limits have been exceeded. For example, the user may enter data regarding risk levels for the entire user account as well as individual trades, such that if the amount is capital required to cover current positions exceeds a certain amount, then the user may decide to close out positions rather than risk the loss of capital. If it is determined that the user risk limits have not been exceeded at 516, the method proceeds to 518. Otherwise, the method proceeds to 520 where cover trades for futures contracts or options are selected that could prevent further capital loss. The method then proceeds to 522 where the recommended cover trades are presented to the user. The method proceeds to 524.

At 524, it is determined whether a user selection has been received. For example, the user can be notified according to a predetermined notification regimen, or other suitable user selection criteria may be used. If a user selection is made, the method proceeds to 533 and the trade is executed. Otherwise, the method proceeds to 534 and terminates without any trade being executed.

Method 500 allows user account information to be analyzed to determine whether additional capital must be provided or futures contract or option trades must be performed so as to limit potential loss, based on requirements of the Chicago Board of Trade, other governing bodies, user risk profiles, or other criteria. In this manner, users can limit their downside potential without operator intervention.

Although preferred and exemplary embodiments of a system and method for commodity futures contract trading risk management have been described in detail herein, those skilled in the art will also recognize that various substitutions and modifications can be made to the systems and methods without departing from the scope and spirit of the appended claims.

What is claimed is:

1. A system for trading commodity futures contracts and options comprising:
a user account system receiving user-entered trade data;
a user information system coupled to the user account system, the user information system providing commodities trading data to users; and
a trading controls system coupled to the user account system, the trading controls system receiving user account data from the user account system and operable to inhibit the user-entered trade data in response to the user account data.

2. The system of claim 1 further comprising a risk management system coupled to the user account system, the risk management system providing cover position data in response to the user-entered trade data.

3. The system of claim 1 further comprising an option selection engine coupled to the user account system, the option selection engine selecting one or more futures contracts and options for presentation to the user based upon the user-entered trade data.

4. The system of claim 1 further comprising a standard portfolio analysis of risk interface system coupled to the user account system, the standard portfolio analysis of risk interface system transmitting user portfolio data to a standard portfolio analysis of risk system and receiving account capital requirements that are based on the user portfolio data.

5. The system of claim 1 further comprising a commodity futures market interface system coupled to the user account system, the futures market interface system receiving option availability and price data and futures contract availability and price data from one or more futures brokers systems and providing the option availability and price data and the futures contract availability and price data to the user.

6. The system of claim 1 further comprising a user system coupled to the user account system via a communications medium, the user system operable to receive data from the user interface, to generate user input prompts based on the data, and to transmit user-entered response data to the user interface.

7. The system of claim 2 wherein the risk management system further comprises an account monitor operable to generate cover data based upon the user account data and to transmit the cover data to the user.

8. A system for trading commodity futures contracts and options comprising:
a user account system receiving user trade data; and
a risk management system coupled to the user account system, the risk management system receiving the user trade data and user risk data from the user account system and generating cover data based upon the user trade data and the user risk data.

9. The system of claim 8 wherein the risk management system further comprises an option selection engine coupled to the user account system and the risk management system, the option selection engine receiving user trade data and user risk data and selecting one or more cover trades based on the user trade data and the user risk data.

10. The system of claim 9 further comprising a commodity futures interface system coupled to the option selection engine, the futures interface system receiving futures contract data and option data from one or more commodities brokers and providing the futures contract data and the option data to the option selection engine.

11. The system of claim 8 wherein the risk management system further comprises an account monitor system receiving user account data, the user risk data, and futures contract price data, the account monitor system generating trade data based upon the user account data, the user risk data and the futures contract price data.

12. A method for trading commodity futures contracts and options comprising:
receiving futures contract trade data;
retrieving user account data;
determining whether the user has enough liquid capital in a user account to cover a commodity futures contract trade based upon the futures contract trade data and the user account data; and
executing the futures contract trade if the user has enough liquid capital in the user account to cover the futures contract trade.

13. The method of claim 12 further comprising presenting the user with one or more cover trade positions based upon user account data and the futures contract trade.

14. The method of claim 12 wherein presenting the user with one or more cover trade positions based upon the user account data and the futures contract trade further comprises:
retrieving user risk data from the user account data;
determining whether the user risk data includes stop loss data; and
selecting the cover trade positions based on the stop loss data.

15. The method of claim 12 wherein receiving user trade data comprises:
receiving account cover requirements from a Systematized Portfolio Analysis of Risk System; and
determining that a trade is required to cover the account based upon the user account data and the account cover requirements.

16. The method of claim 12 wherein receiving user trade data comprises:
prompting the user to select one or more cover trade options;
receiving a user-entered cover trade selection; and
executing the user-entered cover trade.

17. The method of claim 12 wherein receiving user trade data comprises:
receiving account cover requirements from a Systematized Portfolio Analysis of Risk System; and
receiving SPAN data; and
determining that a trade is required based on user account data and the account cover requirements.
